(19) United States
(12) Patent Application Publication
(10) Pub. No.: US 2016/0203153 A1
(43) Pub. Date: Jul. 14, 2016

(54) COMPUTING DEVICE AND CLOUD STORAGE METHOD OF THE COMPUTING DEVICE

(71) Applicant: HON HAI PRECISION INDUSTRY CO., LTD., New Taipei (TW)

(72) Inventors: KUAN-CHIAO PENG, New Taipei (TW); YEN-HUNG LIN, New Taipei (TW)

(21) Appl. No.: 14/692,320

(22) Filed: Apr. 21, 2015

(30) Foreign Application Priority Data
Jan. 12, 2015 (CN) 201510014024.7

(51) Int. Cl. G06F 17/30

(52) U.S. Cl. CPC G06F 17/30123; G06F 17/30091; G06F 17/30203

(57) ABSTRACT

A cloud storage method is applied in a computing device. The computing device connects to a cloud storage device, a database server, and one or more client computers. The computing device establishes one or more data tables in the database server, and records information related to files and folders stored in the cloud storage device in the data tables. In response to a first request for merging multiple folders into a first folder received from a client computer, the computing device creates the first folder in the cloud storage device. The computing device further adds files and sub-folders contained in the multiple folders into the first folder, and adds information related to the first folder into the data tables. The computing device further modifies information related to the files and sub-folders contained in the multiple folders stored in the data table.

### CROSS-REFERENCE TO RELATED APPLICATIONS

This application claims priority to Chinese Patent Application No. 201510014024.7 filed on Jan. 12, 2015, the contents of which are incorporated by reference herein.

### FIELD

The subject matter herein generally relates to cloud computing technology, and particularly to a computing device and a cloud storage method of the computing device.

### BACKGROUND

Cloud storage enables users to access files in a network conveniently. After files are uploaded to cloud storage space in the network, users can download or retrieve the files anytime, anywhere. However, it is inconvenient for users to merge two or more folders into a single one in the cloud storage.

### BRIEF DESCRIPTION OF THE DRAWINGS

Implementations of the present technology will now be described, by way of example only, with reference to the attached figures.

FIG. 1 is a block diagram of one example embodiment of a hardware environment for executing a cloud storage system.

FIG. 2 is a block diagram of one embodiment of function modules of the cloud storage system.

FIG. 3 is a flowchart of one example embodiment of a cloud storage method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

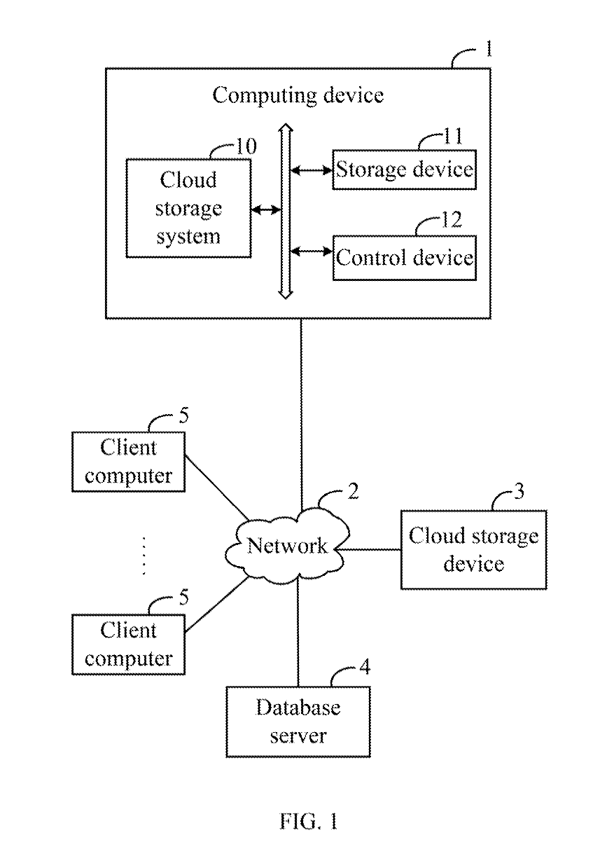

FIG. 1 is a block diagram of one example embodiment of a hardware environment for executing a cloud storage system 10. The cloud storage system 10 is installed and run in a computing device 1. The computing device 1 can be connected to a cloud storage device 3, a database server 4, and a plurality of client computers 5 through a network 2. The computing device 1 can include a storage device 11 and at least one control device 12.

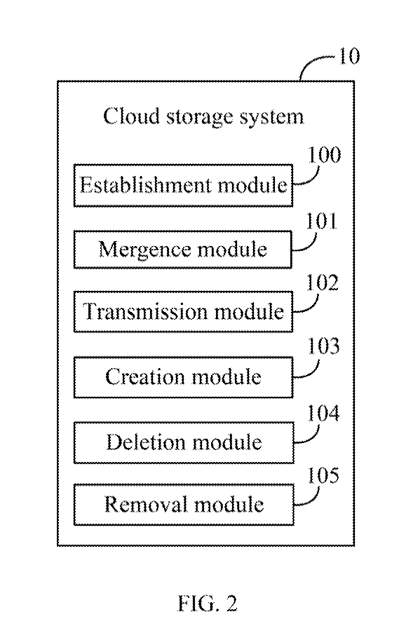

The cloud storage system 10 can include a plurality of function modules (shown in FIG. 2) that provide a cloud storage service including a function of merging two or more folders into a single folder to the client computers 5.

The storage device 11 can include some type(s) of non-transitory computer-readable storage medium, for example a hard disk drive, a compact disc, a digital video disc, or a tape drive. The storage device 11 stores the computerized codes of the function modules of the cloud storage system 10.

The control device 12 can be a processor, an application-specific integrated circuit (ASIC), or a field programmable gate array (FPGA), for example. The control device 12 can execute computerized codes of the function modules of the cloud storage system 10 to realize the functions of the computing device 1.

The cloud storage device 3 can be a direct attached storage (DAS), a storage area network (SAN), or a network attached storage (NAS), for example. The cloud storage device 3 stores files uploaded from the client computers 5.

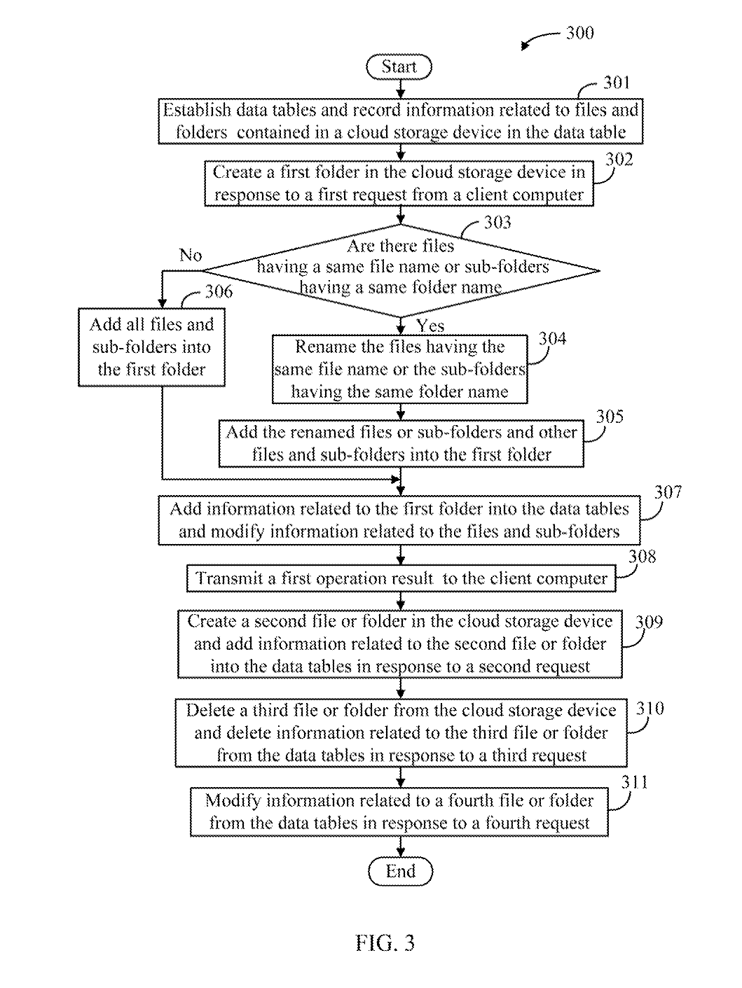

FIG. 2 is a block diagram of one embodiment of function modules of the cloud storage system 10. The function modules can include an establishment module 100, a mergence module 101, a transmission module 102, a creation module 103, a deletion module 104, and a removal module 105. The process modules 100-105 can include computerized codes in the form of one or more programs, which provide at least the functions needed to execute the steps illustrated in FIG. 3.

The establishment module 100 is configured to establish one or more data tables in the database server 4, and records information related to files and folders stored in the cloud storage device 3 in the one or more data tables. In one embodiment, the creation module 100 creates a folder data table and a file data table. The folder data table records information related to folders stored in the cloud storage device 3, such as folder ID, folder name, parent folder ID, parent folder name, and folder creation time. The file data table records information related to files stored in the cloud storage device 3, such as file ID, file name, containing folder ID, file creation time, file storage path. A containing folder of a file is a folder that contains the file. In one example, a folder ID of a certain folder is “Folder 001” and a containing folder ID of a certain file is “Folder 001.” Therefore, the certain file is contained in the certain folder.

The mergence module 101 is configured to receive a first request for merging multiple folders into a first folder from a client computer 5. In response to the first request, the mergence module 101 creates the first folder in the cloud storage device 3, and adds files and sub-folders contained in the multiple folders into the first folder.

In one embodiment, the mergence module 101 can determine whether there are files having a same file name or sub-folders having a same folder name contained in the multiple folders. If there are no files having a same file name or sub-folders having a same folder name contained in the multiple folders, the mergence module 101 adds all files and sub-folders contained in the multiple folders into the first folder. If there are files having a same file name or sub-folders having a same folder name contained in the multiple folders, the mergence module 101 renames the files having the same file name or the sub-folders having the same folder name in the multiple folders, and adds the renamed files or sub-folders and other files and sub-folders contained in the multiple folders into the first folder. For example, the multiple folders include folders “Folder1”, “Folder2”, and “Folder3”, each of the folders “Folder2” and the folder “Folder3” includes a sub-folder “Folder2_sub2”. In this case, the mergence module 101 renames the sub-folder “Folder2_sub2” in the folder “Folder2” as “Folder2_sub2(1)” and renames the sub-folder “Folder2_sub2” in the folder “Folder3” as “Folder2_sub2(2)”. The mergence module 101 adds the sub-folders “Folder2_sub2(1)” and “Folder2_sub2(2)” and other files and sub-folders contained in the folders “Folder1”, “Folder2”, and “Folder3” into the first folder.

In another embodiment, if there are files having a same file name or sub-folders having a same folder name contained in the multiple folders, the mergence module 101 can select one file from the files having the same file name or select one sub-folder from the sub-folders having the same folder name, and replaces other files having the same file name with the selected file or replaces other sub-folders having the same folder name with the selected sub-folder. For example, the mergence module 101 selects a last modified file from the files having the same file name or selects a last modified folder from the folders having the same folder name contained in the multiple folders, and replaces the other files having the same file name with the last modified file or replaces the other folders having the same folder name with the last modified folder. In this embodiment, the mergence module 101 adds the selected file or sub-folder and other files and sub-folders contained in the folders into the first folder.

The mergence module 101 is further configured to add information related to the first folder into the data tables, and modify information related to the files and sub-folders contained in the multiple folders stored in the data tables. For example, the mergence module 101 adds a folder ID, a folder name, a parent folder ID, and a folder creation time of the first folder into the data tables, and modifies containing folder IDs of the files and sub-folders contained in the multiple folders in the data tables.

The transmission module 102 is configured to transmit a first operation result corresponding to the first request to the client computer 5. In one embodiment, the first operation result can include information indicating success, failure, and/or exception.

The creation module 103 is configured to receive a second request for creating a second file or a second folder from the client computer 5, create the second file or the second folder in the cloud storage device 3 in response to the second request, and add information related to the second file or the second folder into the data tables.

The deletion module 104 is configured to receive a third request for deleting a third file or a third folder from the client computer 5, delete the third file or the third folder from the cloud storage device 3 in response to the third request, and delete information related to the third file or the third folder from the data tables.

The removal module 105 is configured to receive a fourth request for removing a fourth file or a fourth folder from a first containing folder to a second containing folder from the client computer 5, and modify information related to the fourth file or the fourth folder from the data tables in response to the fourth request.

In one embodiment, the cloud storage system 10 provides a user interface to receive the first, second, third, and fourth requests from the client computer 5.

In one embodiment, the transmission module 102 is further configured to transmit a second operation result corresponding to the second request, a third operation result corresponding to the third request, and a fourth operation result corresponding to the fourth request to the client computer 5.

FIG. 3 is a flowchart of one example embodiment of a cloud storage method. In the embodiment, the method is performed by execution of computer-readable software program codes or instructions by a control device, such as at least one processor of a computing device.

Referring to FIG. 3, a flowchart is presented in accordance with an example embodiment. The method 300 is provided by way of example, as there are a variety of ways to carry out the method. The method 300 described below can be carried out using the configurations illustrated in FIGS. 1-2, for example, and various elements of these figures are referenced in explaining method 300. Each block shown in FIG. 3 represents one or more processes, methods, or subroutines, carried out in the method 300. Furthermore, the illustrated order of blocks is illustrative only and the order of the blocks can be changed. Additional blocks can be added or fewer blocks may be utilized without departing from this disclosure. The method 300 can begin at block 301.

At block 301, an establishment module establishes one or more data tables in a database server, and records information related to files and folders stored in a cloud storage device in the one or more data tables. In one embodiment, the creation module creates a folder data table and a file data table. The folder data table records information related to folders stored in the cloud storage device, such as folder ID, folder name, parent folder ID, parent folder name, and folder creation time. The file data table records information related to files stored in the cloud storage device, such as file ID, file name, containing folder ID, file creation time, file storage path.

At block 302, a mergence module receives a first request for merging multiple folders into a first folder from a client computer, and creates the first folder in the cloud storage device in response to the first request.

At block 303, the mergence module determines whether there are files having a same file name or sub-folders having a same folder name contained in the multiple folders.

If there are files having a same file name or sub-folders having a same folder name contained in the multiple folders, at block 304, the mergence module renames the files having the same file name or the sub-folders having the same folder name in the multiple folders. In another embodiment, if there are files having a same file name or sub-folders having a same folder name contained in the multiple folders, the mergence module selects one file from the files having the same file name or selects one sub-folder from the sub-folders having the same folder name, and replaces other files having the same file name with the selected file or replaces other sub-folders having the same folder name with the selected sub-folder.

At block 305, the mergence module adds the renamed files or sub-folders and other files and sub-folders contained in the multiple folders into the first folder. As described in block 304, if the mergence module selects one file from the files having the same file name or selects one sub-folder from the sub-folders having the same folder name, and replaces other files having the same file name with the selected file or replaces other sub-folders having the same folder name with the selected sub-folder, at block 305, the mergence module adds the selected file or sub-folder and other files and sub-folders contained in the folders into the first folder.

If there are no files having a same file name or sub-folders having a same folder name contained in the multiple folders, at block 306, the mergence module adds all files and sub-folders contained in the multiple folders into the first folder. The flow goes to block 307.

At block 307, the mergence module adds information related to the first folder into the data tables, and modifies information related to the files and sub-folders contained in the multiple folders stored in the data tables. For example, the mergence module adds a folder ID, a folder name, a parent folder ID, and a folder creation time of the first folder into the data tables, and modifies containing folder IDs of the files and sub-folders contained in the multiple folders in the data tables.

At block 308, a transmission module transmits a first operation result corresponding to the first request to the client computer. In one embodiment, the first operation result can include information indicating success, failure, and/or exception.

At block 309, a creation module receives a second request for creating a second file or a second folder from the client computer, creates the second file or the second folder in the cloud storage device in response to the second request, and adds information related to the second file or the second folder into the data tables.

At block 310, a deletion module receives a third request for deleting a third file or a third folder from the client computer, deletes the third file or the third folder from the cloud storage device in response to the third request, and deletes information related to the third file or the third folder from the data tables.

At block 311, a removal module receives a fourth request for removing a fourth file or a fourth folder from a first containing folder to a second containing folder from the client computer, and modifies information related to the fourth file or the fourth folder from the data tables in response to the fourth request.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A cloud storage method executable by a control device of a computing device, the computing device connected to a cloud storage device, a database server, and a plurality of client computers, the method comprising:
establishing one or more data tables in the database server, and recording information related to files and folders stored in the cloud storage device in the data tables; and
in response to a first request for merging multiple folders into a first folder received from one of the client computers, creating the first folder in the cloud storage device, adding files and sub-folders contained in the multiple folders into the first folder, adding information related to the first folder into the data tables, and modifying information related to the files and sub-folders contained in the multiple folders stored in the data table.

2. The method according to claim 1, further comprising:
in response to a second request for creating a second file or a second folder received from the client computer, creating the second file or the second folder in the cloud storage device, and adding information related to the second file or the second folder into the data tables.

3. The method according to claim 1, further comprising:
in response to a third request for deleting a third file or a third folder received from the client computer, deleting the third file or the third folder from the cloud storage device, and deleting information related to the third file or the third folder from the data tables.

4. The method according to claim 1, further comprising:
in response to a fourth request for removing a fourth file or a fourth folder from a first containing folder to a second containing folder received from the client computer, modifying information related to the fourth file or the fourth folder from the data tables.

5. The method according to claim 1, further comprising:
if there are files having a same file name or sub-folders having a same folder name contained in the multiple folders, renaming the files having the same file name or the sub-folders having the same folder name in the multiple folders, and adding the renamed files or sub-folders and other files and sub-folders contained in the multiple folders into the first folder.

6. The method according to claim 1, wherein the information related to folders comprises folder ID, folder name, and parent folder ID.

7. The method according to claim 1, wherein the information related to files comprises file ID, file name, containing folder ID, and file storage path.

8. A computing device connectable to a cloud storage device, a database server, and a plurality of client computers, the computing device comprising:
a control device; and
a storage device storing one or more programs which when executed by the control device, causes the control device to perform operations comprising:
establishing one or more data tables in the database server, and recording information related to files and folders stored in the cloud storage device in the data tables; and
in response to a first request for merging multiple folders into a first folder received from one of the client computers, creating the first folder in the cloud storage device, adding files and sub-folders contained in the multiple folders into the first folder, adding information related to the first folder into the data tables, and modifying information related to the files and sub-folders contained in the multiple folders stored in the data table.

9. The computing device according to claim 8, wherein the operations further comprise:
in response to a second request for creating a second file or a second folder received from the client computer, creating the second file or the second folder in the cloud storage device, and adding information related to the second file or the second folder into the data tables.

10. The computing device according to claim 8, wherein the operations further comprise:
in response to a third request for deleting a third file or a third folder received from the client computer, deleting the third file or the third folder from the cloud storage device, and deleting information related to the third file or the third folder from the data tables.

11. The computing device according to claim 8, wherein the operations further comprise:
in response to a fourth request for removing a fourth file or a fourth folder from a first containing folder to a second containing folder received from the client computer, modifying information related to the fourth file or the fourth folder from the data tables.

12. The computing device according to claim 8, wherein the operations further comprise:
if there are files having a same file name or sub-folders having a same folder name contained in the multiple folders, renaming the files having the same file name or the sub-folders having the same folder name in the multiple folders, and adding the renamed files or sub-folders and other files and sub-folders contained in the multiple folders into the first folder.

13. The computing device according to claim 8, wherein the information related to folders comprises folder ID, folder name, and parent folder ID.

14. The computing device according to claim 8, wherein the information related to files comprises file ID, file name, containing folder ID, and file storage path.

15. A non-transitory storage medium having stored thereon instructions that, when executed by a control device of a computing device, causes the control device to perform a cloud storage method, the computing device connected to a cloud storage device, a database server, and a plurality of client computers, the method comprising:
establishing one or more data tables in the database server, and recording information related to files and folders stored in the cloud storage device in the data tables; and
in response to a first request for merging multiple folders into a first folder received from one of the client computers, creating the first folder in the cloud storage device, adding files and sub-folders contained in the multiple folders into the first folder, adding information related to the first folder into the data tables, and modifying information related to the files and sub-folders contained in the multiple folders stored in the data table.

16. The non-transitory storage medium according to claim 15, wherein the method further comprises:
in response to a second request for creating a second file or a second folder received from the client computer, creating the second file or the second folder in the cloud storage device, and adding information related to the second file or the second folder into the data tables.

17. The non-transitory storage medium according to claim 15, wherein the method further comprises:
in response to a third request for deleting a third file or a third folder received from the client computer, deleting the third file or the third folder from the cloud storage device, and deleting information related to the third file or the third folder from the data tables.

18. The non-transitory storage medium according to claim 15, wherein the method further comprises:
in response to a fourth request for removing a fourth file or a fourth folder from a first containing folder to a second containing folder received from the client computer, modifying information related to the fourth file or the fourth folder from the data tables.

19. The non-transitory storage medium according to claim 15, wherein the method further comprises:
if there are files having a same file name or sub-folders having a same folder name contained in the multiple folders, renaming the files having the same file name or the sub-folders having the same folder name in the multiple folders, and adding the renamed files or sub-folders and other files and sub-folders contained in the multiple folders into the first folder.

20. The non-transitory storage medium according to claim 15, wherein the information related to folders comprises a folder ID, a folder name, and a parent folder ID, and the information related to files comprises a file ID, a file name, a containing folder ID, and a file storage path.
